(19) United States
(12) Patent Application Publication
(10) Pub. No.: US 2025/0131427 A1
(43) Pub. Date: Apr. 24, 2025

(54) BOT PREVENTION TECHNIQUES

(71) Applicant: Mysten Labs, Inc., Palo Alto, CA (US)

(72) Inventors: Konstantinos Chalkias, Menlo Park, CA (US); Georgios Digkas, Palo Alto, CA (US)

(73) Assignee: Mysten Labs, Inc., Palo Alto, CA (US)

(21) Appl. No.: 18/765,401

(22) Filed: Jul. 8, 2024

Related U.S. Application Data
(60) Provisional application No. 63/591,364, filed on Oct. 18, 2023.

(51) Int. Cl. G06Q 20/40; H04L 9/32

(52) U.S. Cl. CPC G06Q 20/401; H04L 9/3213; G06Q 2220/00

(57) ABSTRACT

The present technology pertain to verifying user identity using a proof of satisfaction such as a token, including a non-fungible token. The present technology includes receiving, by a smart contract on a distributed ledger, a request to engage in a transaction, where the smart contract requires an originator of the transaction to prove that it satisfies a requirement that is verifiable by an authority in order to conduct the transaction, and where the requirement is that the originator of the transaction proves that it is not a bot. The smart contract receives a pointer to a proof of satisfaction of the requirement. The proof of satisfaction is verified by following the pointer. The method also includes conducting the transaction after verifying that the requirement has been satisfied.

### CROSS-REFERENCE TO RELATED APPLICATIONS

This application claims the benefit of and priority to U.S. provisional application 63/591,364 filed Oct. 18, 2023, which is expressly incorporated by reference herein in its entirety.

### BACKGROUND

Completely Automated Public Turing test to tell Computers and Humans Apart (CAPTCHA) methods protect websites from spam and abuse, and is a method of bot mitigation that requires users to pass a challenge test to prove that they are human. CAPTCHA typically uses a risk analysis engine to keep automated software from engaging in abusive activities through tests that are usually based on image recognition, audio transcription, or logic puzzles. For example, a user may be asked to select all the images that contain a traffic light, or to type the words they hear in an audio clip.

CAPTCHA tests are effective in preventing bots from performing tasks that require human intelligence or interaction. However, CAPTCHA tests can also be annoying or frustrating for legitimate users, especially if they are too difficult or frequent. Moreover, CAPTCHA tests may not be accessible for users with disabilities or low bandwidth.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example system for bypassing identity challenge questions in accordance with an example embodiment.

FIG. 2 illustrates an example routine for verifying a human actor in a distributed ledger transaction in accordance with an example embodiment.

FIG. 3 illustrates a flowchart for verifying a human identity in response to a transaction request in accordance with an example embodiment.

FIG. 4 illustrates an example service that creates a registry object in accordance with an example embodiment.

FIG. 5 illustrates an example verification service in accordance with an example embodiment.

FIG. 6 illustrates an interaction service in accordance with an example embodiment.

FIG. 7A illustrates a variable setting service in accordance with an example embodiment.

FIG. 7B illustrates a cloning service in accordance with an example embodiment.

FIG. 7C illustrates a variable setting service in a CAPTCHA directory in accordance with an example embodiment.

FIG. 7D illustrates a publishing service in accordance with an example embodiment.

FIG. 7E illustrates a server start service in accordance with an example embodiment.

FIG. 7F illustrates a user interface service in accordance with an example embodiment.

FIG. 8 illustrates an example flow diagram for a Registry Rate Limit in accordance with an example embodiment.

FIG. 9 illustrates an example rate limiting service that creates a registry object in accordance with an example embodiment.

FIG. 10 illustrates a rate limiting interaction service in accordance with an example embodiment.

FIG. 11A-11C illustrates a flow diagram for a token rate limit in accordance with an example embodiment.

FIG. 12 illustrates registry object creation in accordance with an example embodiment.

FIG. 13 illustrates a registry service in accordance with an example embodiment.

FIG. 14 illustrates a deregistration service in accordance with an example embodiment.

FIG. 15 illustrates token interaction subject to rate limiting in accordance with an example embodiment.

FIG. 16 shows an example of a system for implementing certain aspects of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Digital agreements, such as self-executing contracts, are becoming increasingly common as more transactions are taking place online. Smart contracts operate as self-executing contracts with the terms of the agreement directly written into the code. They can be services that automatically execute and enforce the terms of a contract when predetermined conditions are met, without the need for intermediaries like lawyers or centralized authorities to oversee the process. This allows a wider variety of users easy access to contracts that can be applied to various fields, including finance (e.g., for payments and loans), supply chain management, video game sales, real estate, voting systems, in-app transactions, and more.

Various blockchain platforms are well-known for enabling the creation and deployment of smart contracts, which offer characteristics such as autonomy, decentralization, security, efficiency, and cost reduction. For example, once deployed on a blockchain or a similar decentralized platform, smart contracts operate autonomously. They execute according to their coded instructions without external interference. Smart contracts typically run on blockchain networks, which are decentralized and distributed ledgers, thereby ensuring transparency, immutability, and eliminating the need for a central authority. Smart contracts also eliminate intermediaries, reducing the time and costs associated with traditional contract execution, as well as minimizing the potential for errors. Moreover, the terms and execution of smart contracts are stored on the blockchain, making them highly secure and resistant to tampering or unauthorized changes.

The security around blockchain networks relies on identity verification. Validating a human identity—as opposed to a bot masquerading as a person-reduces the risk of fraudulent activities within smart contracts. It ensures that the parties involved are who they claim to be, reducing the chances of impersonation or identity theft. Confirming the identities of participants in a smart contract also helps establish trust between parties who may not have a prior relationship. This verification builds confidence that the contractual obligations will be fulfilled. Moreover, verifying human identity helps ensure compliance with laws related to Know Your Customer (KYC) and Anti-Money Laundering (AML) regulations, and enforcement of legal agreements by providing a clear record of who was involved with certain transactions. Verifying human identity, therefore, and enforcement of legal agreements by providing a clear record of who was involved with certain transactions safeguards against unauthorized access and manipulation of the contract by malicious actors.

However, it's important to note that while verifying human identity can offer these advantages, it also raises concerns related to case of use, privacy, and data security. Balancing these aspects while implementing identity verification in smart contracts is crucial. Moreover, any system that verifies human identity must be convenient and implemented in a way that doesn't constrain real transactions taking place. The systems and methods herein describe example embodiments that use a human identity verification service to generate a reusable, signed token that allows users to bypass additional human identity verification tests when those tests become too frequent, difficult, or inaccessible to certain users.

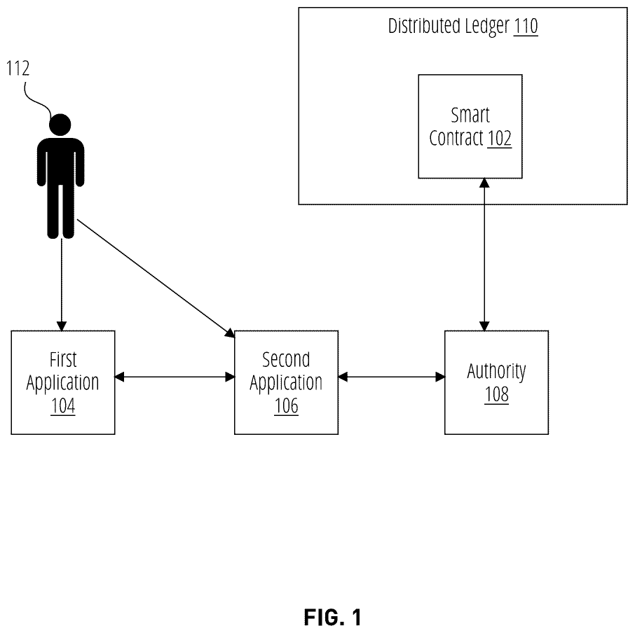

FIG. 1 illustrates an example system for bypassing identity challenge questions in accordance with some embodiments. The system includes a verification or challenge system that verifies the human identity of user 112 and then bypasses the verification or challenge system when the tests posed to the user 112 become too frequent, difficult, or inaccessible to certain users. In FIG. 1, which illustrates one example, a first application 104 presents a challenge test generated by a second application 106 that is a way of verifying that the user is a human and not a bot. For example, the challenge test can be a CAPTCHA or other similar service. The user 112 is asked to solve the test. If the user 112 passes the test successfully, the second application 106 can send back a token to the user 112, an authority 108 in connection with a distributed ledger 110, or both. The token can act as proof that the user 112 has passed the challenge test, which can be reused in subsequent transactions needing verification of user 112's human identity.

The first application 104 can be one or more websites, web applications, mobile applications, intranet portals, web portals, web services and APIs, content management system (CMS), blog or wiki platforms that can receive user 112 input to conduct a transaction or other action that requires verification of the user's 112 human identity. The first application 104 can present challenges (e.g., CAPTCHA) that are easy for humans to solve but difficult for automated scripts or bots. These challenges often include distorted text, image recognition, puzzles, or simple tasks that require human-like reasoning, such as selecting specific images from a grid or solving math problems. The purpose of CAPTCHA is to prevent automated software from performing actions that could be harmful, such as creating multiple accounts, spamming forms, or conducting fraudulent activities on websites. By requiring users to complete these challenges, websites aim to ensure that interactions come from genuine human users rather than automated programs.

The second application 106 can send the token to the authority 108, which can be, for example, an oracle. In the context of blockchain technology, an “oracle” can refer to a system or entity that provides external data to smart contracts or decentralized applications (DApps) on the blockchain. Distributed ledger 110, such as a blockchain, for example, can be isolated from external data sources, and can operate in a trustless and deterministic manner. Authority 108 can serve as intermediaries that enable a smart contract 102 on the distributed ledger 110 to interact with data or events occurring outside the blockchain. They play a crucial role in bringing real-world information into blockchain-based systems. In some embodiments, authority 108 can be either centralized or decentralized. Centralized authorities 108 rely on a single entity to provide data, which can introduce a degree of trust into the system. Decentralized authorities 108, on the other hand, use multiple sources of data and consensus mechanisms to ensure data accuracy and reliability. In some embodiments, authority 108 aggregates data from multiple sources to provide a consensus value, reducing the impact of outliers or inaccuracies in individual data feeds. In some embodiments, the systems disclosed can use chain-link networks, which are decentralized authority 108 networks that aim to connect smart contracts 102 with real-world data. It utilizes a network of node operators to source and verify external data. In summary, authority 108 in the blockchain can act as one or more bridges between smart contracts 102 and external data sources, allowing DApps to make decisions and execute actions based on real-world information.

Smart contracts 102 can be self-executing contracts with the terms of the agreement directly written into code. They can run on blockchain platforms such as distributed ledger 110 and automatically execute when predefined conditions are met. Smart contracts 102 can, in some embodiments, eliminate the need for intermediaries, such as banks or legal systems, by automating and enforcing the terms of an agreement, which can include financial transactions, asset transfers, or any other actions. Once deployed, smart contracts 102 operate autonomously, executing without the need for human intervention as long as the predefined conditions are met. This automation reduces the risk of human error and fraud. Moreover, smart contracts 102 operate in a trustless environment, meaning participants in the contract do not need to trust each other. They rely on the security and consensus mechanisms of the blockchain to ensure the execution of the contract terms. Smart contracts 102 have a wide range of potential applications, including supply chain management, insurance, voting systems, token sales (Initial Coin Offerings or ICOs), decentralized autonomous organizations (DAOs), and many more. Smart contracts 102 have the potential to revolutionize various industries by reducing costs, increasing efficiency, and enabling new forms of decentralized applications.

The distributed ledger 110 can store the user 112 token (e.g., an authorization non-fungible token (NFT)) for reuse in later transactions or actions, such as a subsequent transaction involving smart contract 102. Therefore, instead of producing another CAPTCHA challenge to user 112 through the second application 106, the subsequent transaction can proceed with the token stored on the distributed ledger 110.

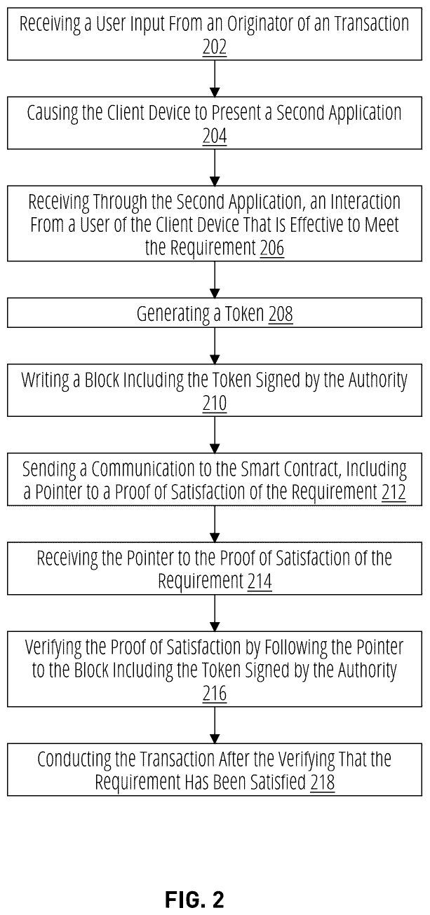

FIG. 2 illustrates an example routine in conjunction with FIG. 1 for verifying a human actor in a distributed ledger transaction in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving a user input from an originator of a transaction at block 202. For example, the first application 104 illustrated in FIG. 1 may receive user input from an originator of a transaction and/or other event for which their human identity must be verified. The user input can include, for example, performing an activity in the first application 104, such as engaging with a user interface (UI), clicking a link, engaging with a website portal, etc. The activity in the first application 104 can be backed by a transaction recorded on a distributed ledger 110. The transaction, for example, can be associated with a smart contract 102.

The smart contract 102 includes at least one requirement that is verifiable by an authority 108 in order to conduct the transaction. The requirement can be, for example, verification that the user 112 has a human identity rather than being a bot masquerading as a person. Other requirements may include, but are not limited to, compatibility and adherence to standards (such as ERC-20 for tokens on Ethereum) are essential to ensure interoperability within the blockchain ecosystem, resource management requirements, legal compliance, security and audit requirements, etc. Any requirement that allows the smart contract 102 to self-execute within the terms of the agreement associated with the smart contract 102 may be used.

The first application 104 can be executed by a client device associated with user 112. The first application 104 can be any one or more websites, web applications, mobile applications, intranet portals, web portals, web services and APIs, content management system (CMS), blog or wiki platforms that can receive user 112 input to conduct a transaction or other action that requires verification of the user's 112 human identity. In some embodiments, the first application 104 can be a game and the transaction can be to write a game event or object to the distributed ledger 110.

According to some examples, the method includes causing the client device to present a second application 106 at block 204. For example, the first application 104 illustrated in FIG. 1 may cause the client device to present a second application 106. In some embodiments, the second application 106 is provided by the authority 108 (which can be, for example, an oracle).

According to some examples, the method further includes receiving, through the second application 106, an interaction from a user 112 of the client device that is effective to meet the requirement at block 206. For example, the authority 108 illustrated in FIG. 1 may receive, through the second application 106, an interaction from a user 112 of the client device that is effective to meet the requirement. The authority 108 can be an oracle that operates in concert with the second application 106. For example, the second application 106 can be a test provider that can provide a test to prove the requirement, such as a CAPTCHA test.

In some embodiments, the authority 108 can also be the test provider and does not need a separate oracle. A separate oracle is not needed, for example, when the test provider signs a token (e.g., an authorization NFT) indicating that the originator of the transaction, as identified by their address unique to the originator of the transaction, has passed a test provided by the test provider and posts the signed token to the distributed ledger.

In some embodiments, the second application 106 or the authority 108 can provide a know-your-customer (KYC) process. This can be separate or in addition to the human verification addressed above. The KYC process can be required to comply with laws or policies for some types of transactions.

In some embodiments, the second application 106 or the authority 108 can provide a know-your-customer (KYC) process. This can be separate or in addition to the human verification addressed above.

In some embodiments, the second application 106 or the authority 108 can be used to prove that the transaction originated from a particular user interface. This can be separate or in addition to the human verification or the KYC addressed above. The proof that the transaction was originated from the particular user interface can be beneficial when it is desired that the originator of the transaction originates the transaction from the particular user interface as opposed to via an API or spoofed user interface.

All of the human verification, the KYC of a user, or the verification that a transaction began using a particular user interface are just some examples of a requirement that is verifiable by the authority. Each could result in a transaction written to the distributed ledger that can be read by others requiring proof that the requirement was met, or the proof can be provided by the authority 108 directly to the smart contract. As will be addressed herein, the satisfaction of the requirement can also result in an NFT being minted and issued to the user, where holding the NFT is itself proof of satisfaction of the requirement.

According to some examples, the method includes generating a token at block 208. For example, the authority 108 illustrated in FIG. 1 may generate a token (e.g., an authorization NFT). The token is signed by the authority 108 and includes an address unique to the originator of the transaction that verifies that the originator of the transaction has passed the requirement. The authority 108 can be an oracle that verifies that the requirement has been determined to be satisfied by the first application 104. In some embodiments, the authority 108 is a service that is operable with a plurality of test providers to verify that requirements were determined to be satisfied by one of the plurality of test providers.

According to some examples, the method includes writing a block including the token signed by the authority 108 at block 210. For example, the distributed ledger 110 illustrated in FIG. 1 may write a block including the token signed by the authority 108. The token is a proof of satisfaction of the requirement and includes data written to the distributed ledger 110 that includes a token signed by the authority 108 that includes an address unique to an originator of the transaction that verifies that the originator of the transaction has passed the requirement.

According to some examples, the method includes sending a communication to the smart contract 102, including a pointer to a proof of satisfaction of the requirement at block 212. For example, the authority 108 illustrated in FIG. 1 may send a communication to the smart contract 102, including a pointer to a proof of satisfaction of the requirement. The proof of satisfaction is the block including the token signed by the authority 108. In some embodiments, the proof of satisfaction can include data stored in a registry of the authority 108, where the registry provides the benefit that when the originator of the transaction satisfies the requirement, a record is created in the registry. This allows the smart contract 102 to determine whether to accept that the originator of the transaction has met the requirement recently enough and/or often enough. Therefore, when the pointer to the proof of satisfaction is a pointer to the registry of the authority 108 that can be queried by the smart contract 102, the registry can allow the proof of satisfaction to be reused in subsequent transactions without needing another proof of satisfaction.

According to some examples, the method includes receiving the pointer to the proof of satisfaction of the requirement at block 214. For example, the smart contract 102 illustrated in FIG. 1 may receive the pointer to the proof of satisfaction of the requirement.

According to some examples, the method includes verifying the proof of satisfaction by following the pointer to the block including the token signed by the authority 108 at block 216. For example, the smart contract 102 illustrated in FIG. 1 may verify the proof of satisfaction by following the pointer to the block including the token signed by the authority 108. The verifying is accomplished when the token identifies the originator of the transaction as a human identity and the token is signed by the authority 108.

The block written to the distributed ledger 110 can be reused to prove that the originator of the transaction satisfied at least one requirement of the smart contract 102 for more than one transaction. The token (e.g., an authorization NFT) signed by the authority 108 is written in a standard format for tokens from the authority 108. The verifying includes further determining that the token signed by the authority 108 matches the standard structure of tokens from the authority 108, whereby the smart contract has further confidence that the token is authentic from the authority 108. In this way, the smart contract 102 may get circumstantial evidence that the authority 108 is authentic and is not being spoofed because of the structure of the token. The proof of satisfaction includes data written to the distributed ledger 110 in the form of token, and more specifically, a non-fungible token (NFT) minted to the address unique to the originator of the transaction. The NFT, for example, can be minted after the originator of the transaction satisfies the requirement, and in embodiments, the NFT is the proof of satisfaction of the requirement. The NFT can be associated with a time-to-live (TTL), whereby the NFT expires after the TTL has timed out.

In some embodiments, the message in the block written to the distributed ledger 110 includes the TTL. The TTL can be, for example, any parameter that defines the lifespan or longevity of the token in the distributed ledger 110. For example, the TTL can represent an amount of time for which the token will be reused within smart contract 102 transactions within the distributed ledger 110 (e.g., a TTL value of 10 minutes, 2 days, 3 weeks, etc.), and/or the TTL can represent a number of token reuses that are authorized (e.g., a TTL value of three reuses, 10 reuses, etc.). The verifying that the requirement of a smart contract 102 is satisfied includes determining that the TTL in the message has not expired. When the TTL reaches zero, the token is no longer valid and a new requirement (e.g., CAPTCHA test) must be administered to verify the user 112 has a human identity.

According to some examples, the method includes conducting the transaction after verifying that the requirement has been satisfied at block 218. For example, the smart contract 102 illustrated in FIG. 1 may conduct the transaction after verifying that the requirement has been satisfied. In some examples, the transaction can be to write a new high score, and/or the transaction can be to mint an NFT for an in-game object.

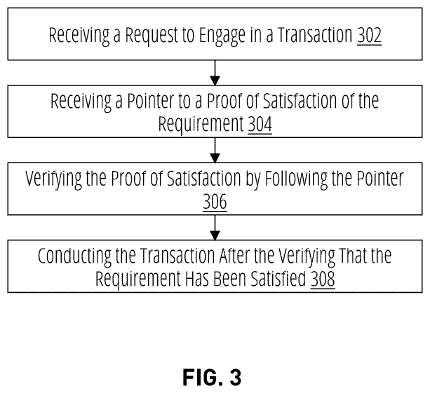

FIG. 3 illustrates an example routine for verifying a human identity in response to a transaction request in accordance with an example embodiment. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving a request to engage in a transaction at block 302. For example, the smart contract 102 illustrated in FIG. 1 may receive a request from a device of the user 112 to engage in a transaction. The smart contract 102 requires that an originator of the transaction prove that it satisfies at least one requirement that is verifiable by an authority 108 (such as an oracle or other similar service) in order to conduct the transaction. In some embodiments, the requirement is that the originator of the transaction of the transition proves that it is not a bot.

For example, once the user passes the token to the second application 106, the second application 106 will check if the token is valid and then sign a message with sign in information, such as the user's address and the current timestamp. The message can contain information about the user's identity and the time of the request. In some embodiments, the message can contain the website's ID if the same second application 106 serves multiple websites, so that the system can distinguish between tokens and in which website the user passed the test.

The authority 108 will then send to the smart contract 102 the signature, the raw message, and the public key. The public key, for example, can be used to verify the signature of the second application 106. The authority 108 will then send the signature, the raw message, and the public key to the smart contract 102. The smart contract 102 will verify if the signed message is valid by using the public key. If the verification is successful, the smart contract 102 will register the user's address as eligible to interact with the smart contract 102. This authorization might be limited to a period of time.

Introducing a CAPTCHA mechanism into DApps through an authority 108, for example an oracle, can be a way to combine web2 and web3 technologies. For example, the CAPTCHA mechanism could primarily serve to verify human interactions and reduce the chances of bots manipulating or exploiting smart contract functions. For example, for Limited Time Sales or drops (e.g., NFT drops, ICOs, or other limited-time sales where high demand is expected), the CAPTCHA system can ensure that participation is predominantly human, minimizing bot-driven unfair advantages. For DApps requiring sign-ups or identity verification, CAPTCHAs can add an extra layer of verification to ensure authenticity. In decentralized platforms where access to certain sections or conditions within smart contracts is restricted or needs to be metered, a CAPTCHA-NFT system can control the flow of users. However, the user experience needs to be considered in these applications. If users are frequently prompted for CAPTCHA, it might become cumbersome and hinder the adoption or usefulness of the DApp. A balanced approach, where the CAPTCHA challenge is used judiciously and strategically without hindering the security and implementation of smart contracts is more effective. Additionally, the decentralized nature of blockchain systems can sometimes clash with centralized verification systems like CAPTCHA.

In some embodiments, DApp systems can determine and/or choose which CAPTCHA systems to incorporate and set their own terms for how frequently the CAPTCHA challenge is required. This allows adaptability to open up many markets for smart contracts 102 needing bot protection in the decentralized world, such as decentralized content contribution platforms, decentralized ad platforms, decentralized competitions, auction platforms, decentralized education platforms, decentralized work platforms, crowdfunding and DAOs, decentralized review platforms, subscription services, decentralized rental and booking platforms, whitelisting, research and data collection DApps, etc.

In some embodiments, the decentralization of CAPTCHA systems can lead to a marketplace where custom CAPTCHA solutions tailored for different DApp needs are offered. DApp services can then choose which CAPTCHA solutions fit best their application without overcomplicating the user experience. For example, DApp services can select CAPTCHA solutions with the appropriate level of security-some applications and/or smart contracts may require more robust CAPTCHA systems to deter malicious bots, while others may prioritize user-friendliness and choose less intrusive options. A balance can be implemented that minimizes disruptions for legitimate users while still providing the necessary security.

According to some examples, previous CAPTCHA test results can be stored on one or more blocks within the distributed ledger 110, which can then be accessed for the current transaction by the same user 112. For example, the method further includes receiving a pointer to a proof of satisfaction of the requirement at block 304. For example, the smart contract 102 illustrated in FIG. 1 may receive a pointer to a proof of satisfaction of the requirement, which can be stored in a block on the distributed ledger 110. A test provider, for example, can be used to prove the satisfaction of the requirement. The test provider can be a CAPTCHA test provider presented on the first application 104, and the authority 108 is a service that verifies that the CAPTCHA test was passed by the originator of the transaction using the address unique to an originator of the transaction. The CAPTCHA can be provided by the test provider's second application 106. The authority 108 can be an oracle that operates in concert with the test provider (e.g., the second application 106). The oracle verifies that the requirement has been determined to be satisfied by the test provider, such as through a proof of satisfaction that includes data written to the distributed ledger 110 that includes a token signed by the authority 108 that includes an address unique to an originator of the transaction. In combination, this can verify that the originator of the transaction has passed the requirement—e.g., the user 112 has a human identity and is not a bot. The pointer to the data written to the distributed ledger 110 that includes the token signed by the authority 108 can be, for example, a block identifier of a block on the distributed ledger 110. In other words, in some embodiments, the data written to the distributed ledger 110 is essentially a token that can be used in conjunction with a smart contract, and/or can be verified by the smart contract tied to the transaction being conducted/initiated by the user 112.

According to some examples, the method includes verifying the proof of satisfaction by following the pointer at block 306. For example, the smart contract 102 illustrated in FIG. 1 may verify the proof of satisfaction by following the pointer to a block on the distributed ledger 110 that includes the token. Verification can then be accomplished when the token identifies the originator of the transaction, and the token is signed by the authority 108. The token is a proof that the user has passed the challenge test. In this way, the CAPTCHA service can be used by the distributed ledger 110 to generate a reusable challenge test for users that bypass additional CAPTCHA tests when the tests become too frequent, difficult, or inaccessible to certain users. If the user passes the test successfully, the corresponding token can be reused to verify that the user 112 is a human and not a bot.

According to some examples, the method includes conducting the transaction after verifying that the requirement has been satisfied at block 308. For example, the smart contract 102 illustrated in FIG. 1 may conduct the transaction after verifying that the requirement has been satisfied.

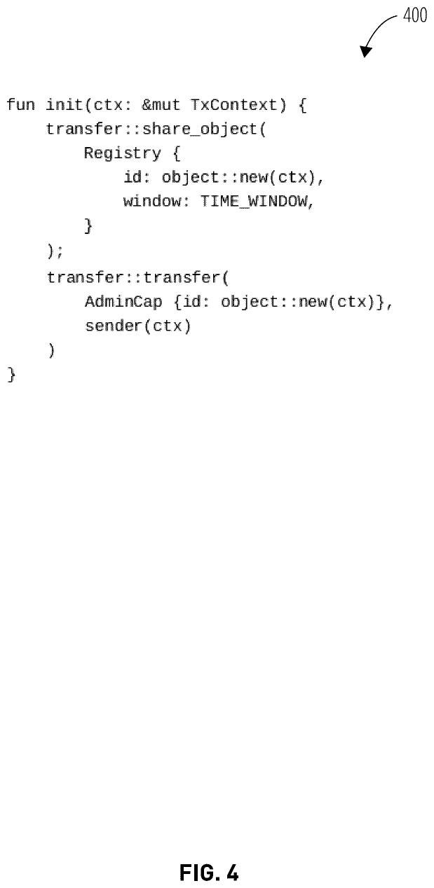

FIG. 4 illustrates an example service that creates a registry object in accordance with an example embodiment, which can be used in conjunction with FIG. 1 for verifying a human actor in a distributed ledger transaction in accordance with some aspects of the present technology. According to some examples, the method includes writing a block including the token signed by the authority 108 at block 210. For example, the distributed ledger 110 illustrated in FIG. 1 may write a block including the token signed by the authority 108. The token is a proof of satisfaction of the requirement and includes data written to the distributed ledger 110 that includes a token signed by the authority 108 that includes an address unique to an originator of the transaction that verifies that the originator of the transaction has passed the requirement.

In order to create a registry that recognizes the token at subsequent transactions with the user 112, a recaptcha:: recaptcha module can create a registry object and an admin capability in the init (initialization) function 400. The init (initialization) function 400 can share the registry object and transfer the admin capability to the sender of the transaction (e.g., the user 112). The publisher will become the owner of the registry object and can control its key-value pairs.

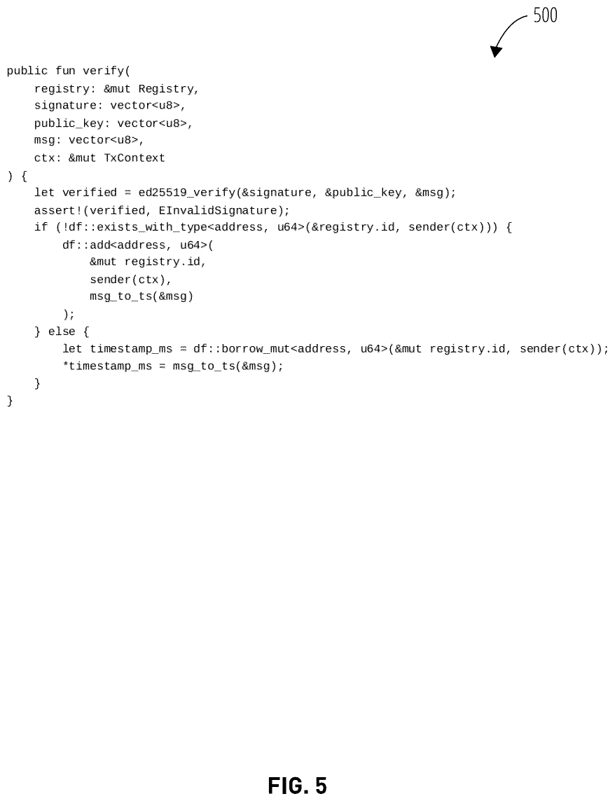

Additionally and/or alternatively, the recaptcha:: recaptcha module allows anyone to register themselves as non-bot by calling the verify function 500, illustrated in FIG. 5. The verify function 500, for example, is a public function that takes the following parameters: registry, signature, public_key, msg, and ctx. The function performs the following steps:
(a) It verifies that the signature is valid for the given public key and message using the ed25519_verify function. If the signature is invalid, it aborts with an EInvalidSignature error.
(b) It checks if the user 112 of the transaction has an entry in the registry.
(c) If the user 112 does not have an entry in the registry, it creates one with the user's address and the timestamp that the message was signed.
(d) If the user 112 already has an entry in the registry, it updates the value with the new timestamp as illustrated in FIG. 5.

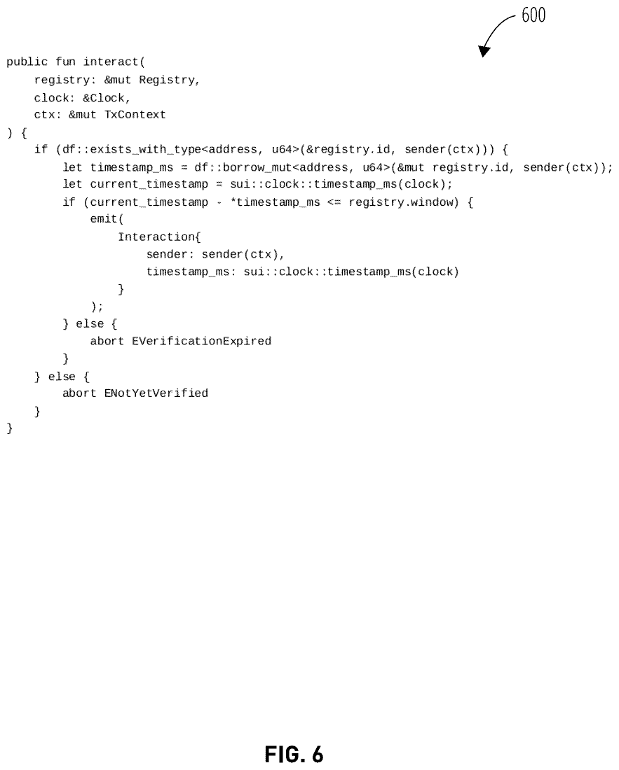

FIG. 6 illustrates an interaction service in accordance with an example embodiment. In some embodiments, the recaptcha::recaptcha module allows anyone to interact with the smart contract by calling the interact function 600. The interact function 600, for example, takes the following parameters: registry, clock, and ctx. These parameters are explained as follows:

Registry: A reference to a Registry object that stores the address and timestamp of each user verified as non-bot.
Clock: A reference to a Clock object that provides the current timestamp in milliseconds.
ctx: A reference to the Transaction Context object.

The interact function (600) executes the following operations:
(a) It verifies whether the user (112) involved in the transaction has been authenticated as a non-bot entity by examining the dynamic fields within the registry object.
(b) Upon successful verification, the function acquires a mutable reference to the registry object's dynamic field that holds the user's (112) verification timestamp.
(c) It then retrieves the current timestamp from the clock object and calculates the time difference between the current and verified timestamps.
(d) If this time difference is less than or equal to the window parameter of the registry object, the function triggers an Interaction event, logging the user's address and the current timestamp.
(e) Conversely, if the time difference exceeds the window parameter the function terminates the process, signaling an EVerificationExpired error.
f. If the user (112) has not been authenticated as a non-bot the function aborts, indicating an ENot Yet Verified error.

The interact function (600) is designed to solely emit events for valid interactions and does not return any values.

As shown in FIG. 1, the smart contract 102 uses the ed25519 digital signature algorithm to verify the authenticity of a message sent by the user 112, although any digital signature algorithm can be used. The message, for example, can be the user's 112 address and the timestamp in milliseconds. The user 112 also provides the public key and the signature of the message.

The smart contract 102 can maintain a registry of verified users, indexed by their address. The registry stores the timestamp of the last verification for each user. There is also a time window parameter that can determine how long a verification is valid.

In some embodiments, the smart contract 102 allows verified users to interact with it by emitting an Interaction event that contains the user's address and the current timestamp. It checks if the user's 112 verification is still within the time window before emitting the event. If not, the smart contract 102 aborts with an error code.

The smart contract 102 creates an AdminCap which allows the owner to access and modify the contract's state. The smart contract also has some constants and structs that define its parameters and data structures as follows:
EVerificationExpired: This means that your verification has expired, and you need to verify again before interacting with the contract.
EInvalidSignature: This means that your signature is invalid or does not match your public key and message.
ENotYetVerified: This means that you have not verified yourself yet and you need to do so before interacting with the contract.
TIME_WINDOW: This is the duration of the time window in milliseconds.
Registry: This is a struct that defines a registry with a unique ID and registers the user's 112 address and the verification timestamp.
Interaction: This is a structure that is used to emit events.
AdminCap: This is a struct that defines an admin capability with a unique id.

In an example, the recaptcha::recaptcha module can be used by creating a CAPTCHA service, creating a CAPTCHA account, and then generating a pair of keys. For example, any CAPTCHA service can be used that supports the CAPTCHA v3 API. This solution (illustrated in FIG. 1) uses CAPTCHA v3 as an example. A CAPTCHA account will be created to use the reCAPTCHA service, and a pair of ed25519 keys can be created. For example, a pair of ed25519 keys (public and private) can be generated using fastcrypto CLI binary or any tool or library that supports any similar algorithms.

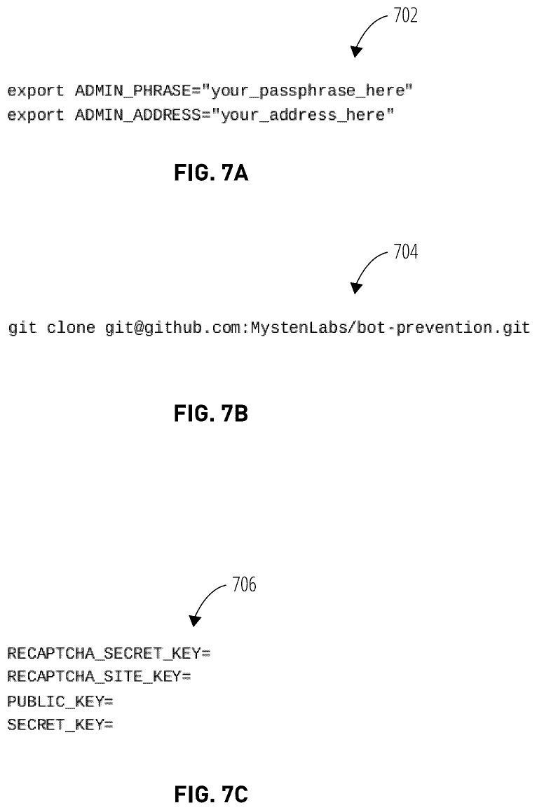

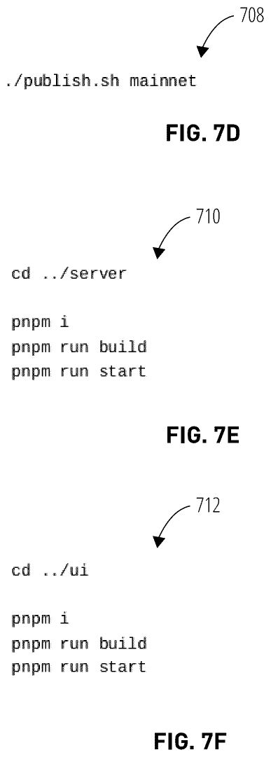

Additionally and/or alternatively, the smart contract 102 can be published, as shown in FIG. 7A-7F. FIG. 7A, for example, illustrates a variable setting service 702 in accordance with an example embodiment. Before running the script, two environment variables need to be set: ADMIN_PHRASE and ADMIN_ADDRESS. The ADMIN_PHRASE is the mnemonic for the account, and the ADMIN_ADDRESS is the hexadecimal address of the account. These variables can be set by running, for example, the following commands illustrated in FIG. 7A in the terminal. Additionally, the bot-prevention repository is cloned 704 as illustrated in FIG. 7B. The following variables are set 706 as illustrated in FIG. 7C in the recaptcha/publish/publish.sh filE. The contracts are published 708 by navigating to the recaptcha/publish directory and executing the following command as illustrated in FIG. 7D. The server is started by navigating to the recaptcha/server directory and executing the following command 710 as illustrated in FIG. 7E, and the user interface (UI) is started by navigating to the recaptcha/ui directory and executing the following command 712 as illustrated in FIG. 7F.

Additionally and/or alternatively, mechanisms can be put into place to minimize bot activity. Once a request to engage in a transaction is received to engage in a transaction, the smart contract 102 may be unable to prove that an originator of the transaction is not a bot.

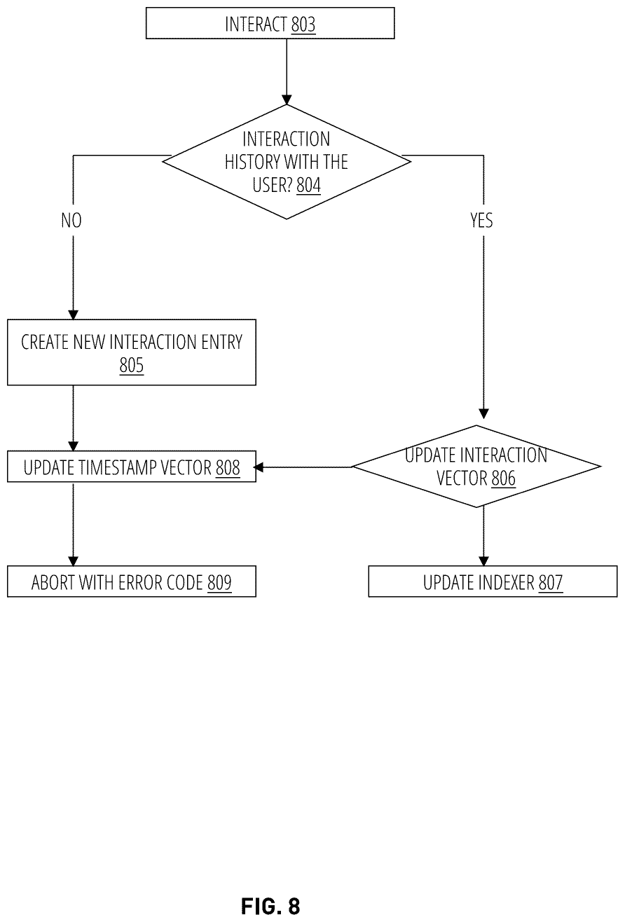

In general, there can be at least 3 approaches to limit bot interactions, namely: CAPTCHA, Registry Rate Limit, and Token Rate Limit. FIG. 8 illustrates an example flow diagram for a Registry Rate limit in accordance with an example embodiment. The Registry Rate Limit, for example, can be an alternative embodiment to limit bot interactions with the smart contract 102 (as opposed to other embodiments such as CAPTCHA and Token Rate Limit). While the Registry Rate Limit methodology does not need to have users 112 prove they are human, or have passed a CAPTCHA challenge, etc., it limits the number of times a user interacts with a smart contract 102 after they've separately proven the same (e.g., equivalent to the results via CAPTCHA or otherwise).

The Registry Rate Limit can be, for example, a smart contract 102 module that implements a rate limit mechanism for interacting with a registry object. The registry object, for example, can be a key-value store that can be shared and controlled by an admin capability. The rate limit mechanism allows users to interact with the registry object only a certain number of times within a time window—otherwise they will be aborted with an error code.

The interact function 600 facilitates interaction between a distributed ledger 110 and a transaction registry. It initiates by verifying 808 whether there is an existing Interaction struct associated with the transaction's user within the registry. This struct comprises a timestamp vector and an indexer pinpointing the most recent interaction's position. When an existing Interaction struct is present, the function mutably borrows it, retrieves the timestamp vector's length, acquires the current timestamp, and computes the update index using the indexer and transaction count.

Subsequently, the function assesses 812 if the timestamp vector has reached its capacity, aligning with the transaction count, and whether the time elapsed since the last recorded timestamp is within the permissible time window. Should both conditions be met, it signifies the user has exceeded the interaction threshold within the designated timeframe, prompting an abort 818 with the error code EStillInCoolDownPeriod. Conversely, if any condition is unmet, the user is permitted to proceed with the registry interaction. The function then updates 812 the timestamp vector: appending the current timestamp and incrementing the indexer if space permits, or overwriting the oldest timestamp and cyclically incrementing the indexer 814 if the vector is full.

If the user does not have an existing Interaction struct in the registry, it means that this is their first interaction with the registry. The function then adds 810 a new Interaction struct to the registry with their address as the key. The Interaction struct contains a singleton vector with the current timestamp and an indexer set to one.

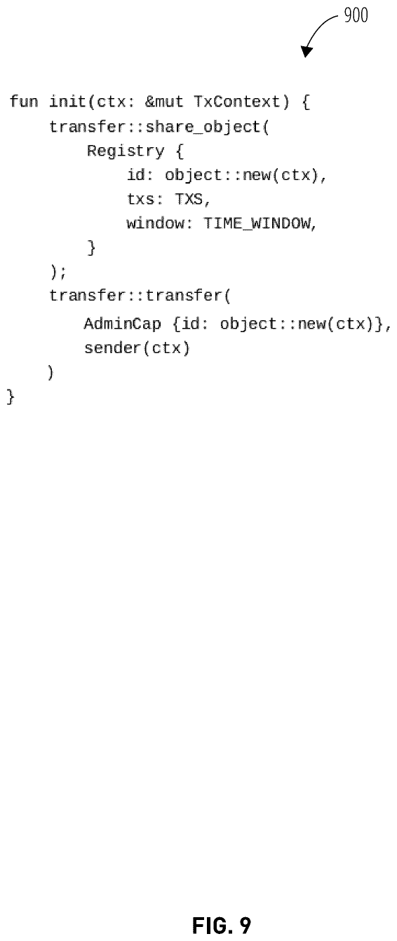

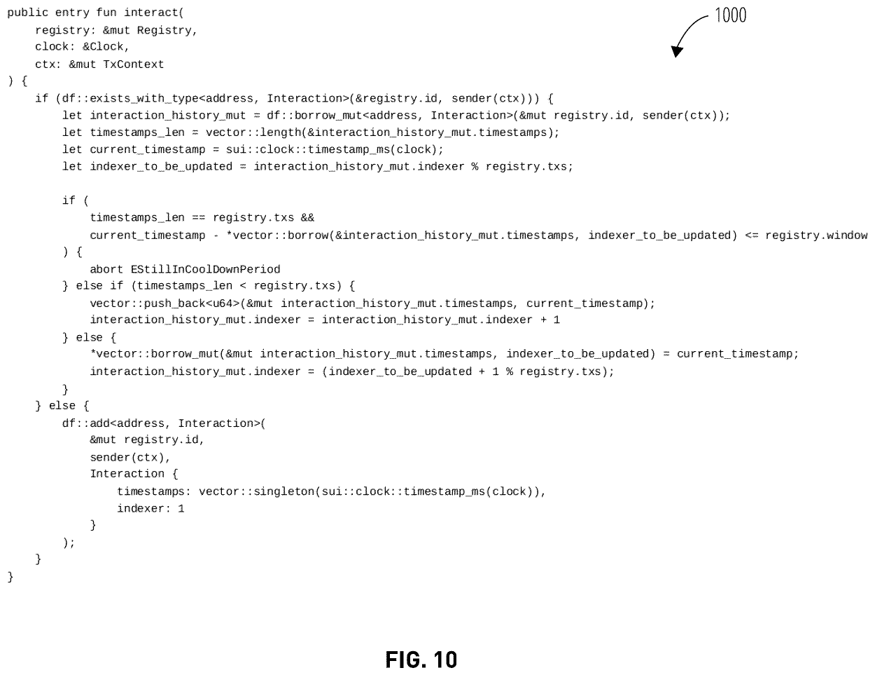

The registry_rate_limit module 900 does the following as shown in FIG. 9 and FIG. 10. The registry_rate_limit module 900 creates a registry object and an admin capability in the init function in FIG. 9. This function can share the registry object and transfer the admin capability to the user of the transaction. The user will become the owner of the registry object and can control its key-value pairs.

FIG. 10, meanwhile, illustrates how the registry_rate_limit module allows anyone to interact with the registry object by calling the interact function 1000. This interact function 1000 will check if the caller has an interaction history with the registry object, and if so, update it according to the rate limit logic. If not, function 1000 will create a new interaction history for the caller. The interaction history is stored as a dynamic field of the registry object, indexed by the caller's address. It consists of a vector of timestamps and an indexer that indicates the position of the oldest timestamp in the vector.

In some embodiments, the smart contract 102 also has some constants and structs that define its parameters and data structures such as, but not limited to:
EStillInCoolDownPeriod: This is an error code for when someone tries to interact while they are in cooldown period.
TXS: This is the number of transactions allowed per time window for each access token.
TIME_WINDOW: This is the duration of the time window in milliseconds.
Registry: This is a struct that defines a registry with a unique ID and a dynamic field that maps addresses to booleans.
Interaction: This is a struct that defines an interaction history with a vector of timestamps and an indexer.
AdminCap: This is a struct that defines an admin capability with a unique ID.

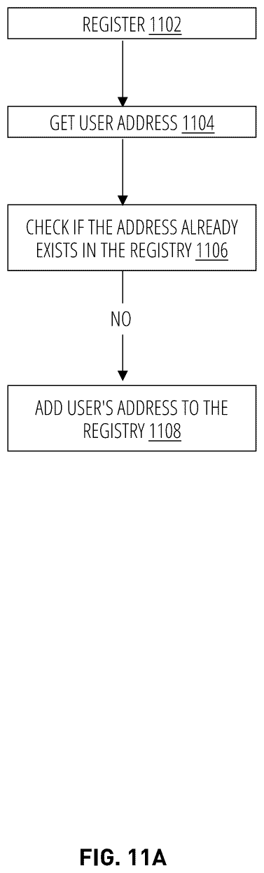

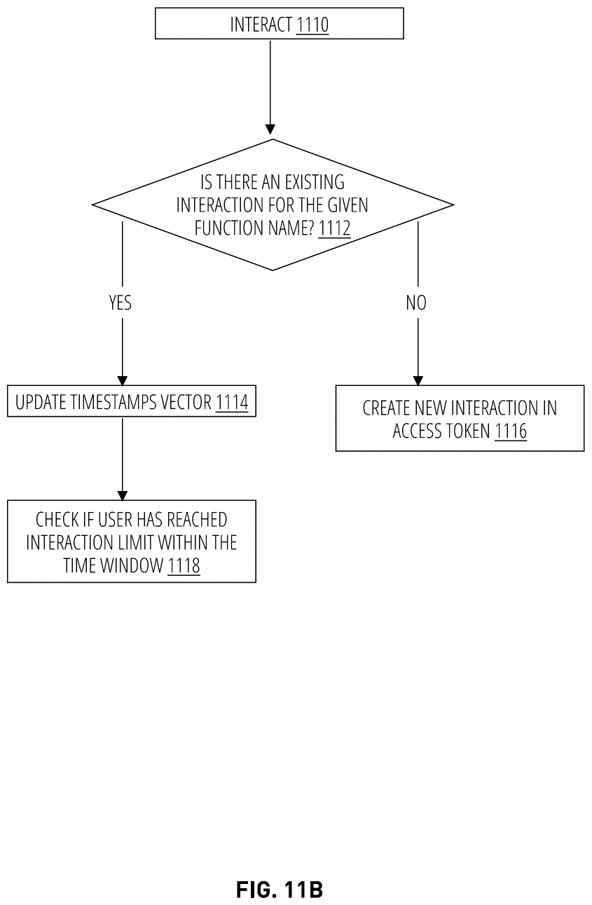

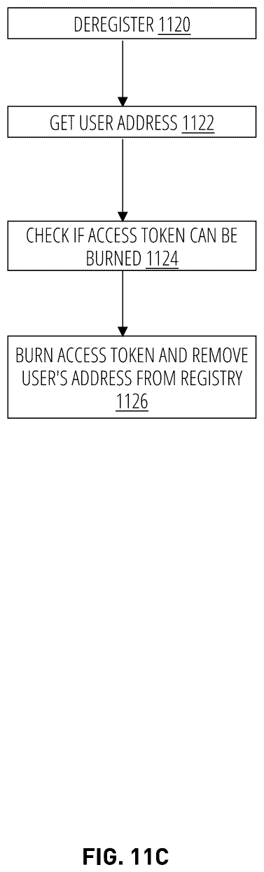

FIGS. 11A-11C illustrates a flow diagram for a token rate limit in accordance with example embodiments. In some embodiments, the smart contract 102 implements a rate limit mechanism for token interactions. It allows users to register 1102 and receive an access token, which they can use to call certain functions of the contract. In some embodiments, the access token is registered after getting the user's 112 address 1104 if and checking of the address already exists at block 1106 with the registry (e.g., distributed ledger 110). If the address does not exist, then the user's 112 address is added 1108 to the registry.

However, even after being registered, each access token has a limit of how many times it can be used within a certain time window. If the user exceeds the limit, they will have to wait until the next window to interact again. The Token Rate Limit, for example, can be an embodiment to limit bot interactions with a smart contract 102 (as an alternative to, or in combination with other embodiments such as CAPTCHA and Registry Rate Limit). While the Token Rate Limit methodology does not have users 112 themselves prove they are human, or have passed a CAPTCHA challenge, etc., it limits the number of times a user interacts with a smart contract 102 after they've separately proven the same (e.g., equivalent to the results via CAPTCHA or otherwise).

For example, the users can interact 1110 with different functions by passing their access token and the Clock, which provides the current timestamp (e.g., in milliseconds, for example). Each function calls the interact function with three parameters: a mutable reference to an AccessToken, a reference to the Clock, and a string that represents the function name. The interact function checks 1112 if there is an existing Interaction for the given function name in the AccessToken. An Interaction contains a vector of timestamps and an indexer that indicates the position of the last interaction. If there is an existing Interaction, the interact function borrows it mutably and updates 1114 the timestamps vector based on the current timestamp, the indexer, and a constant TXS that represents the number of transactions. The interact function also checks 1118 if the user 112 has reached the limit of interactions within a constant TIME_WINDOW that represents the time window for each interaction for this function name, and aborts with an error code EStillInCoolDownPeriod if so. If there is no existing Interaction for the given function name in the AccessToken, the interact function adds 1116 a new Interaction to the AccessToken with a singleton vector of the current timestamp and an indexer set to one.

The users 112 can also deregister 1120 themselves from the Registry and burn their access token by calling the deregister function. The deregister function first gets 1122 the user address and checks 1124 if the access token can be burned. If it cannot be burned, it aborts with an error code ECannotDelete AccessToken. If it can be burned, it destroys 1126 the access token and it removes the user's address from the Registry.

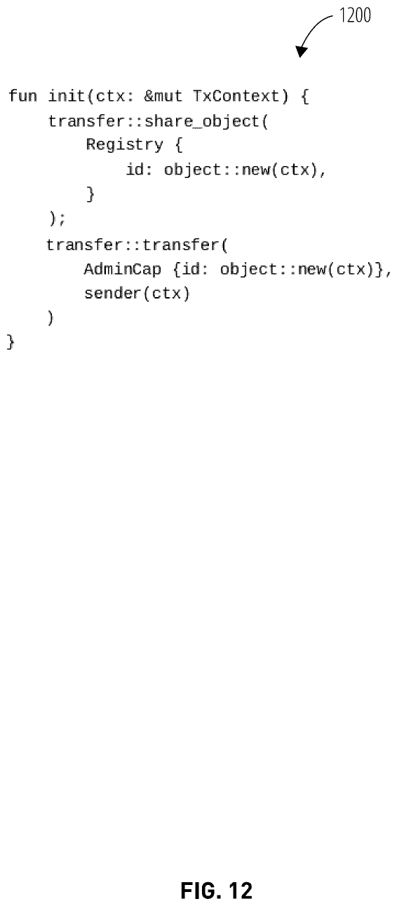

In some embodiments, the token_rate_limit module 1200 does the following as illustrated in FIG. 12 to FIG. 15. FIG. 12 creates a registry object and an admin capability in the init function. This function will share the registry object and transfer the admin capability to the user 112 of the transaction. The user 112 will become the owner of the registry object and can control its key-value pairs.

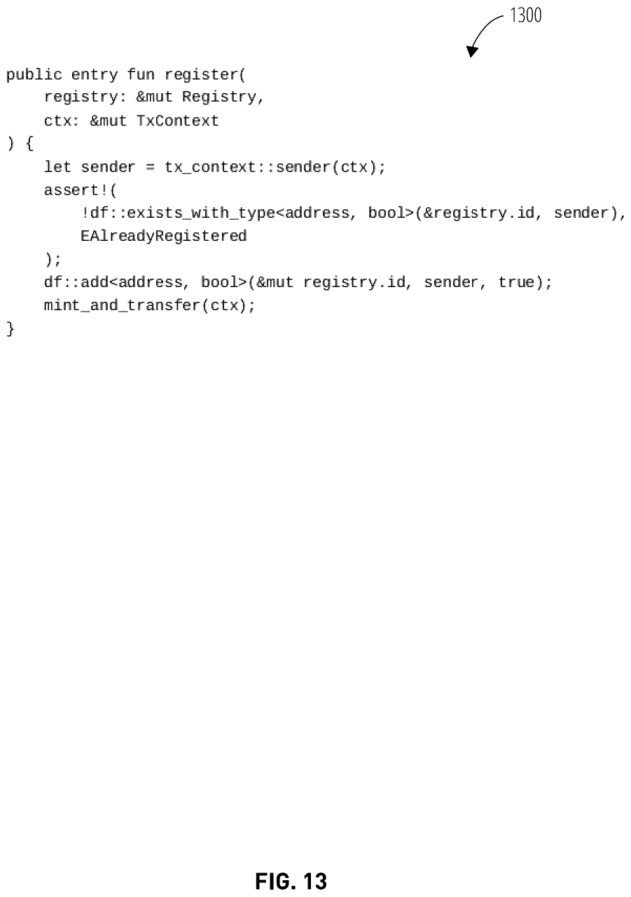

The token_rate_limit module 1300 shown in FIG. 13 allows anyone to register and interact with the contract by calling the register function. This function allows a user to register and receive an access token. It checks that the user is not already registered and adds them to the registry.

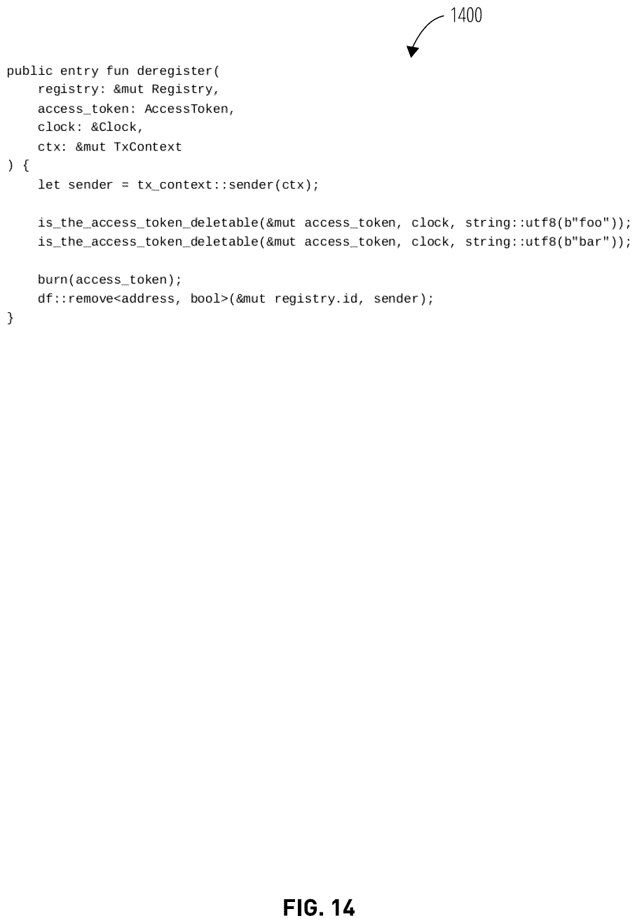

FIG. 14 shows how the token_rate_limit module 1400 allows a registered user to deregister by calling the deregister function. This function allows a user 112 to deregister and burn their access token. It checks that the access token is deletable and removes the user 112 from the registry.

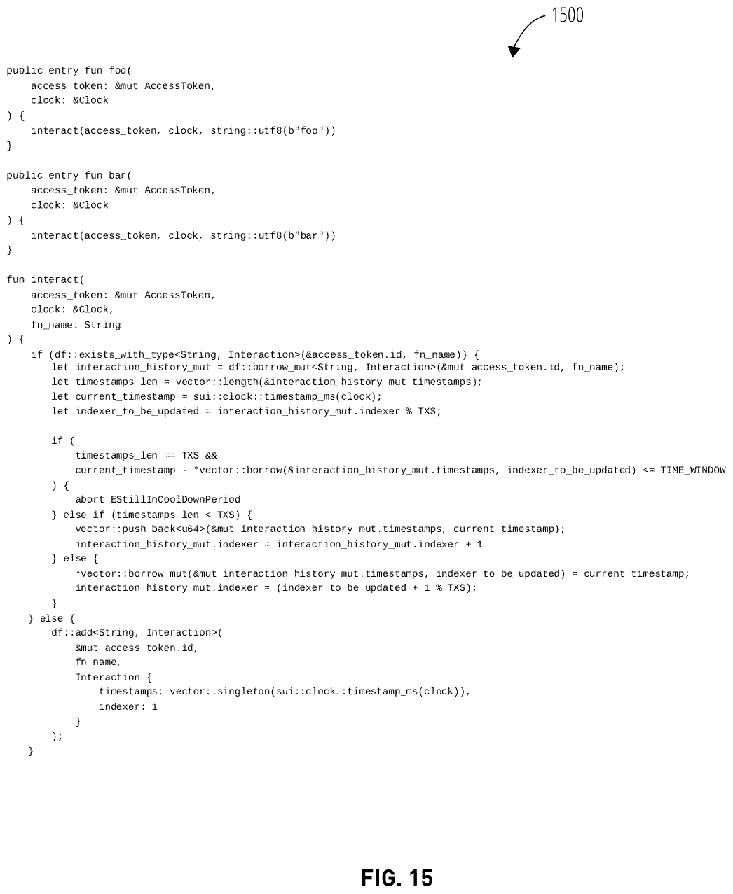

FIG. 15 illustrates token interaction subject to rate limiting in accordance with an example embodiment. The foo and bar functions 1500 shown in FIG. 15 show examples of a token interaction that is subject to rate limit. They check that the user 112 has a valid access token and that they have not exceeded their limit in the current time window. If so, it updates their interaction history and performs some logic.

The smart contract 102 also has some constants and structs that define its parameters and data structures:
EAlreadyRegistered: This is an error code for when someone tries to register again.
EStillInCoolDownPeriod: This is an error code for when someone tries to interact while they are in cooldown period.
TXS: This is the number of transactions allowed per time window for each access token.
TIME_WINDOW: This is the duration of the time window in milliseconds.
AccessToken: This is a struct that defines an access token with a unique id.
Registry: This is a struct that defines a registry with a unique id and a dynamic field that maps addresses to booleans.
Interaction: This is a struct that defines an interaction history with a vector of timestamps and an indexer.
AdminCap: This is a struct that defines an admin capability with a unique id.

A blockchain network such as the distributed ledger 110 shown in FIG. 1 can include various nodes that are configured to maintain a blockchain in accordance with some embodiments. A node, which is associated with an end website within the blockchain network, is one of many nodes within the distributed network that includes one or more smart contracts 102. The blockchain network can include any number of nodes corresponding to smart contract parties and websites allowing customers access to services related to the smart contracts 102 that have been enabled as nodes on blockchain network. The blockchain process represented from the beginning (e.g., the customer or user 112) to the smart contract parties has nodes within blockchain network that provide a record of id verifications associated with the associated service(s) on a real time or near real time basis. Each node on blockchain network-including all suppliers, vendors, and customers-include a copy of blockchain ledger including all ID verifications associated with the product. Blockchain ledger has been duplicated across all the nodes.

The blockchain network can guarantee that a verification is original and backed by specific enterprises, vendors, suppliers, and/or partners. In some embodiments, blockchain can (1) certify the event that provides the user access, and (2) certify the ID of the user. As a result, since the blockchain network is distributed across many nodes, no one point of failure can provide a false certification. This means that an access attempt that is received about a user can be verified as coming from a genuine human (e.g., not a bot). This means that a second CAPTCHA is unnecessary and can be bypassed, instead providing the identification through the blockchain itself (e.g., reusing the original CAPTCHA challenge for one or more subsequent interactions related to the smart contract).

A blockchain ledger can be any linked ledger system. In the embodiment shown, blockchain ledger 150 is a ledger system within a distributed blockchain, where a continuously growing list of records, called blocks, is linked to one or more previous blocks. Blocks can be continuously updated as blockchain ledger is modified with subsequent ID verifications, transactions, data, updates, etc. from the nodes within the blockchain network. For example, a block can record that a certain user has passed a CAPTCHA challenge question and is a human user rather than a bot. A later block can record that the ID of the user was automatically verified (and no CAPTCHA challenge was sent to the user) by the intermediate vendor of node, and another subsequent block can record that the ID of the user was automatically verified (and no CAPTCHA challenge was sent to the user). This record can extend throughout the entire smart contract, where the reuse of the CAPTCHA verification can dynamically extend throughout a period of time depending on the needs of the smart contract. For example, the CAPTCHA verification can be used for the entire duration of the smart contract, or the CAPTCHA verification can be used for a period of time that expires when the system determines the verification is no longer secure enough,

In some embodiments, the blockchain network may be, in part or in whole, a public distributed blockchain. However, one of skill in the art will understand that any architecture that supports a chain of custody of individual identifications can be used to the same effect.

Each node can include functionality to read and/or access the blockchain ledger, record verification, identifications, transactions, data, updates, etc. A customer may also access the blockchain ledger at the user interface on the node, subject to certain rules, policies, and restrictions set by a smart contract service applied across the blockchain network. For example, a customer may be granted only read access to a portion of the data on blockchain ledger so that sensitive internal business data for, say, a supplier, is not made public. Other customers may be authorized to write to the blockchain ledger of the present technology.

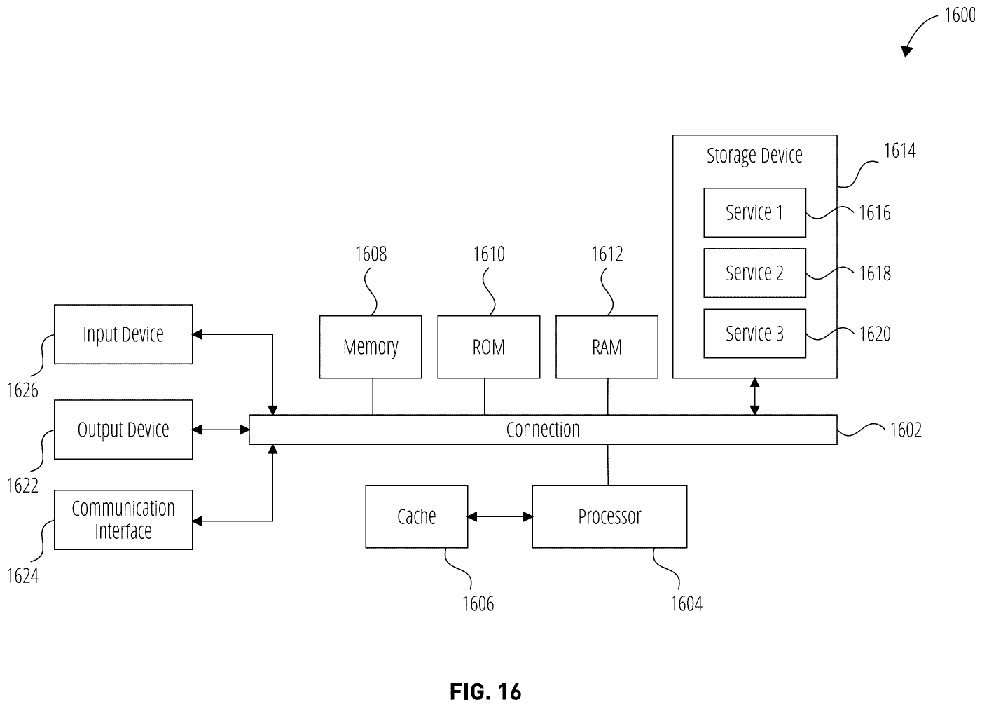

FIG. 16 shows an example of computing system 1600, which can be for example any computing device making up the first application 104, the second application 106, authority 108, and/or distributed ledger 110 with smart contract 102, or any component thereof in which the components of the system are in communication with each other using connection 1602. Connection 1602 can be a physical connection via a bus, or a direct connection into processor 1604, such as in a chipset architecture. Connection 1602 can also be a virtual connection, networked connection, or logical connection.

In some embodiments, computing system 1600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1600 includes at least one processing unit (CPU or processor) 1604 and connection 1602 that couples various system components including system memory 1608, such as read-only memory (ROM) 1610 and random access memory (RAM) 1612 to processor 1604. Computing system 1600 can include a cache of high-speed memory 1606 connected directly with, in close proximity to, or integrated as part of processor 1604.

Processor 1604 can include any general purpose processor and a hardware service or software service, such as services 1616, 1618, and 1620 stored in storage device 1614, configured to control processor 1604 as well as a special-purpose processor where software instructions are incorporated into the actual processor design. Processor 1604 may essentially be a completely self-contained computing system, containing multiple cores or processors, a bus, memory controller, cache, etc. A multi-core processor may be symmetric or asymmetric.

To enable user interaction, computing system 1600 includes an input device 1626, which can represent any number of input mechanisms, such as a microphone for speech, a touch-sensitive screen for gesture or graphical input, keyboard, mouse, motion input, speech, etc. Computing system 1600 can also include output device 1622, which can be one or more of a number of output mechanisms known to those of skill in the art. In some instances, multimodal systems can enable a user to provide multiple types of input/output to communicate with computing system 1600. Computing system 1600 can include communication interface 1624, which can generally govern and manage the user input and system output. There is no restriction on operating on any particular hardware arrangement, and therefore the basic features here may easily be substituted for improved hardware or firmware arrangements as they are developed.

Storage device 1614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1614 can include software services, servers, services, etc., that when the code that defines such software is executed by the processor 1604, it causes the system to perform a function. In some embodiments, a hardware service that performs a particular function can include the software component stored in a computer-readable medium in connection with the necessary hardware components, such as processor 1604, connection 1602, output device 1622, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal Computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for verifying a human actor in a distributed ledger transaction, the method comprising:
receiving, by a smart contract on a distributed ledger, a request to engage in a transaction, wherein the smart contract requires an originator of the transaction to prove that it satisfies a requirement that is verifiable by an authority in order to conduct the transaction, wherein the requirement is that the originator of the transaction proves that it is not a bot;
receiving, by the smart contract a pointer to a proof of satisfaction of the requirement;
verifying the proof of satisfaction by following the pointer; and
conducting the transaction after verifying that the requirement has been satisfied.

2. The method of claim 1, wherein the proof of satisfaction includes data written to the distributed ledger that includes a token signed by the authority that verifies that the originator of the transaction has passed the requirement, wherein the pointer to the data written to the distributed ledger that includes the token signed by the authority is a block identifier of a block on the distributed ledger.

3. The method of claim 2, wherein the token signed by the authority is written in a standard format for tokens from the authority, the method further comprising:
further determining that the token signed by the authority matches a standard structure of tokens from the authority.

4. The method of claim 2, wherein the data in the block written to the distributed ledger includes a time-to-live (TTL), and the verifying that the requirement of a smart contract is satisfied includes determining that the TTL has not expired.

5. The method of claim 2, wherein the authority is an oracle that operates in concert with a test provider, wherein the test provider is used to prove the requirement, and the oracle verifies that the requirement has been determined to be satisfied by the test provider.

6. The method of claim 5, wherein the oracle is a service that is operable with a plurality of test providers to verify that requirements were determined to be satisfied by one of the plurality of test providers.

7. The method of claim 5, wherein the test provider is a Completely Automated Public Turing test to tell Computers and Humans Apart (CAPTCHA) test provider, and the oracle is a service that verifies that the CAPTCHA test was passed by the originator of the transaction using an address unique to the originator of the transaction.

8. The method of claim 7, wherein the CAPTCHA test is presented within a game.

9. The method of claim 1, wherein the proof of satisfaction includes data stored in a registry of the authority, wherein the pointer to the proof of satisfaction is a pointer to the registry of the authority that can be queried by the smart contract.

10. The method of claim 1, wherein the requirement that is verifiable by the authority also includes proof that the originator of the transaction has completed a know-your-customer (KYC) process, or proof that the transaction was originated from a particular user interface.

11. A computing system comprising:
at least one processor; and
a memory storing instructions that, when executed by the at least one processor, configures the computing system to:
receive, by a smart contract on a distributed ledger, a request to engage in a transaction, wherein the smart contract requires an originator of the transaction to prove that it satisfies a requirement that is verifiable by an authority in order to conduct the transaction, wherein the requirement is that the originator of the transaction proves that it is not a bot;
receive, by the smart contract a pointer to a proof of satisfaction of the requirement; and
verify the proof of satisfaction by following the pointer; and
conduct the transaction after verifying that the requirement has been satisfied.

12. The computing system of claim 11, wherein the proof of satisfaction includes data written to the distributed ledger that includes a token signed by the authority that verifies that the originator of the transaction has passed the requirement, wherein the pointer to the data written to the distributed ledger that includes the token signed by the authority is a block identifier of a block on the distributed ledger.

13. The computing system of claim 12, wherein the token signed by the authority is written in a standard format for tokens from the authority, wherein the instructions further configure the computing system to:
further determine that the token signed by the authority matches a standard structure of tokens from the authority.

14. The computing system of claim 12, wherein the data in the block written to the distributed ledger includes a time-to-live (TTL), and the verifying that the requirement of a smart contract is satisfied includes determining that the TTL has not expired.

15. The computing system of claim 12, wherein the authority is an oracle that operates in concert with a test provider, wherein the test provider is used to prove the requirement, and the oracle verifies that the requirement has been determined to be satisfied by the test provider.

16. A non-transitory computer-readable storage medium comprising instructions that when executed by a computer, cause at least one processor to:
receive, by a smart contract on a distributed ledger, a request to engage in a transaction, wherein the smart contract requires an originator of the transaction to prove that it satisfies a requirement that is verifiable by an authority in order to conduct the transaction, wherein the requirement is that the originator of the transaction proves that it is not a bot;
receive, by the smart contract a pointer to a proof of satisfaction of the requirement; and
verify the proof of satisfaction by following the pointer;
conduct the transaction after verifying that the requirement has been satisfied.

17. The non-transitory computer-readable storage medium of claim 16, wherein the proof of satisfaction includes data written to the distributed ledger that includes a token signed by the authority that verifies that the originator of the transaction has passed the requirement, wherein the pointer to the data written to the distributed ledger that includes the token signed by the authority is a block identifier of a block on the distributed ledger.

18. The non-transitory computer-readable storage medium of claim 17, wherein the token signed by the authority is written in a standard format for tokens from the authority, wherein the instructions further configure the computer to:
further determine that the token signed by the authority matches a standard structure of tokens from the authority.

19. The non-transitory computer-readable storage medium of claim 17, wherein the data in the block written to the distributed ledger includes a time-to-live (TTL), and the verifying the that the requirement of a smart contract is satisfied includes determine that the TTL has not expired.

20. The non-transitory computer-readable storage medium of claim 17, wherein the authority is an oracle that operates in concert with a test provider, wherein the test provider is used to prove the requirement, and the oracle verifies that the requirement has been determined to be satisfied by the test provider.
